(19) United States
(12) Patent Application Publication
(10) Pub. No.: US 2011/0113457 A1
(43) Pub. Date: May 12, 2011

(54) DISTRIBUTED PLATFORM OF TELEVISION BROADCASTING SYSTEM STRUCTURE BASED ON INTERNET PROTOCOL NETWORK

(75) Inventors: Yong Man Kim, Cupertino, CA (US); Haein Jane Kim, Alexandria, VA (US)

(73) Assignee: SYNORO MEDIA, INC., Cupertino, CA (US)

(21) Appl. No.: 12/989,640

(22) PCT Filed: Apr. 25, 2009
(86) PCT No.: PCT/US09/41740

§ 371 Date: Oct. 25, 2010

Related U.S. Application Data
(60) Provisional application No. 61/125,599, filed on Apr. 25, 2008.

(51) Int. Cl. H04N 7/173

(52) U.S. Cl. 725/109

(57) ABSTRACT

A distributed interne protocol television network system is provided which can expand its bandwidth and support an unlimited number of content and program providers because encrypted and packetized video is streamed by the content and program providers directly to the end user through a broadband network and not through a network operations center that is part of the system. The video will appear to the end user as if it came from the network operating center but it does not. The network operating center has a management function that requires less bandwidth. The distributed network structure will include broad-caster servers supplied to each of the content or program providers and acting in cooperation with management software in the network operating center that supports operation of the network.

### CROSS-REFERENCE TO RELATED APPLICATION

This application claims priority from U.S. provisional application 61/125,599 filed on Apr. 25, 2008 by Yong Man Kim and entitled “Distributed Platform of Television Broadcasting System Structure Based on Internet Protocol Network.”

### STATEMENT REGARDING FEDERALLY SPONSORED RESEARCH OR DEVELOPMENT

Not applicable.

### BACKGROUND

1. Field of the Disclosure

The present invention relates to a distributed internet protocol television (IPTV) broadcasting network system and management control system software and devices for such a network.

2. Discussion of the Related Art

For a long time, actually since it was invented, television broadcasting has been transmitting analog and digital signals by frequency modulation. Each channel has its own bandwidth of frequency and this bandwidth is controlled by the government. Television broadcasting of this kind has a limited number of channels due to the limited number of available bandwidths of frequency. Television broadcasting therefore is limited to a very few licensed broadcasters.

Recently, owing to the development of internet technology, video broadcasting through the internet is now possible. This is called internet protocol television or IPTV. This is a form of conventional television broadcasting through the internet rather than using the existing frequency-modulation based transmitting networks.

An internet protocol (IP) based transmitting network provides many different broadcasting structures compared with that of existing frequency based channels. The IP based transmitting network has no fixed or pre-defined concept of channel such as the existing television broadcasting system has. The IP based transmitting network can deliver or transmit as much video data as the bandwidth of the connection to the internet will allow. As a result, adding more channels is easy, whereas addition of such channels is very limited in the frequency based networks.

IPTV systems are increasingly widespread and are substituting for the existing television broadcasting system. IPTV brings benefits to both the broadcasters and subscribers due to its nature as a bidirectional network. Television broadcasting based on IPTV has already begun commercial service. The number of channels is still limited because the IPTV network is broadcasting from one location. Accordingly, the bandwidth is limited, even it is wider than the frequency-modulation based systems. IPTV networks will gradually look very similar to the existing frequency-modulation based television broadcasting system.

The standard concept of current IPTV service is the same as the conventional internet service network structure. The IPTV service provider operates its NOC (Network Operation Center) physically at a single location. The NOC contains a multiple numbers of servers and content in a single location. This physical concentration of the service platform can limit the bandwidth of the network and also limit the number of television channels. Finally, the limited number of channels also limits the potential of the internet network whereby a user may be linked to anywhere or everywhere.

The benefit of an IP platform therefore is diminished if TV broadcasting just changes its transmission system from frequency-modulation to an IP network. IPTV should overcome this bandwidth limitation so that IPTV can be different from existing frequency-modulation based television. IPTV can provide a totally different type of television broadcasting by not just changing the method of transmission but also by providing an unlimited number of channels with a wide range of program providers.

### SUMMARY OF THE DISCLOSURE

The present disclosure provides means that allow any content owner to provide live television broadcasting and thus lowers the entrance barrier to television broadcasting. These means also overcome the limitation of the number of channels due to the limitation of bandwidth of IPTV service providers. The NOC of IPTV service providers using these means will not have the bottle neck that is a common problem in current IPTV platforms, despite the availability of unlimited numbers of channels.

In an aspect of the disclosure, a distributed network structure is provided which has an expanded bandwidth and can support an unlimited number of content providers and an unlimited number of television channels. This distributed network structure includes useful devices which support operation of the network.

The conventional IPTV signal is controlled and transmitted by a network operations center (NOC) in a limited bandwidth. In an aspect of the distributed IPTV network structure according to the disclosure, however, the IPTV signal can be transmitted from each content provider's site. This service can be done at any level, such as from a person's home or work place. Any individual, program provider, media house, corporation, and production agency or producer can broadcast live television at his, her or its location through a broadband network (and in particular, the internet). The distributed IPTV network structure according to the disclosure provides a system for allowing end users to receive and view the broadcasts from the content providers.

The distributed IPTV network structure according to the disclosure has a network operations center (NOC) that controls the protocol of each IPTV broadcasting stream that is being transmitted from a content or program provider's own location or site. The NOC does not transmit the IPTV broadcasting stream. It controls the protocol in order to manage the conditional access system (CAS), the digital right management (DRM), the stream identifier (ID), the stream category, the subscriber management (including billing), and the CPEs (consumer premises equipment).

An aspect of an embodiment of distributed IPTV network structure according to the disclosure preferably comprises a server with access to the content of each content provider located at the site of the content provider (the “broadcaster server”) and software that controls the automated transfer of the multimedia content and broadcast based on the preferences of the end user or subscriber.

Anyone who wants to be a television broadcaster will install the broadcaster server and connect his or her camera to the broadcaster server. The broadcaster server is itself connected to the internet by an Ethernet connection. A NOC runs the software that controls the automated transfer of the multimedia content and broadcasts, based on the end user's preferences as communicated by information from the end user, and by communicating protocols to and receiving information to the broadcaster servers.

A distributed IPTV network design and system according to the disclosure lowers the barriers of television broadcasting by allowing anyone to provide individual TV broadcasting without having to deal with the difficulties of set up, subscriber management, encryption, billing, video camera signal stream management, content management, advertisement, storage management, and so forth. The NOC will handle charging and billing to the end user subscribers, receive payment from them, and make payment to the individual broadcasters. Each broadcaster server includes CAS and DRM and cooperates with the NOC.

The distributed IPTV network design and system according to the disclosure is different from conventional TV or standard IPTV broadcasting because it has a much lower entrance barrier for the broadcaster or content provider. Furthermore, it provides an advanced platform for NOC operation which enables the NOC to manage an essentially unlimited numbers of channels. In contrast, current regular TV and even conventional IPTV have a very limited number of channels due to their lack of frequency or bandwidth, respectively.

The advantages of a distributed network structure of this kind therefore includes an expansion of bandwidth capacity to overcome the limit of bandwidth problems of current most IPTV networks, a dramatic increase of the number of channels by allowing many individuals or private program productions to participate, and reduction of the entrance barrier to television broadcasting. The distributed IPTV network structure according to the disclosure can make possible a next generation television broadcasting that is very different from all existing regular television and IPTV broadcasting.

### BRIEF DESCRIPTION OF DRAWINGS

FIG. 1 is a schematic depiction of a conventional IPTV service structure.

FIG. 2 is a schematic depiction of an embodiment of a distributed platform of IPTV network structure according to the disclosure.

FIG. 3 is a schematic diagram that shows the more detailed structure of the content provider's site in the embodiment of a distributed platform of IPTV network structure of FIG. 2.

FIG. 4 is a block diagram of an embodiment of a broadcaster server for use in the distributed platform of IPTV network structure of FIG. 3.

FIG. 5 is a schematic diagram of an embodiment of a virtual individual service module in an end user's private channel service platform.

FIG. 6 is a schematic diagram showing the graphical structure of an end user's channel platform.

FIG. 7 is a depiction of an end user's channels search display and icon based user interface for channel searching of an embodiment of a distributed IPTV platform according to the disclosure.

FIG. 8 is the depiction of an end user's channels search display and icon based user interface of FIG. 7 marked to indicate a method of searching for a channel and saving it to an end user's defined channel.

FIG. 9 is the depiction of an end user's channels search display and icon based user interface of FIG. 7 marked to indicate an additional application of a method of searching for a channel and saving it to an end user's defined channel.

FIG. 10 is a flow chart of the operation of a virtual individual service module running in a network operating center according to an aspect of the disclosure.

FIG. 11 is a flow chart of the operation of an end user's display device in cooperation with the virtual individual service module running in a network operating center.

### DETAILED DESCRIPTION OF PREFERRED EMBODIMENTS

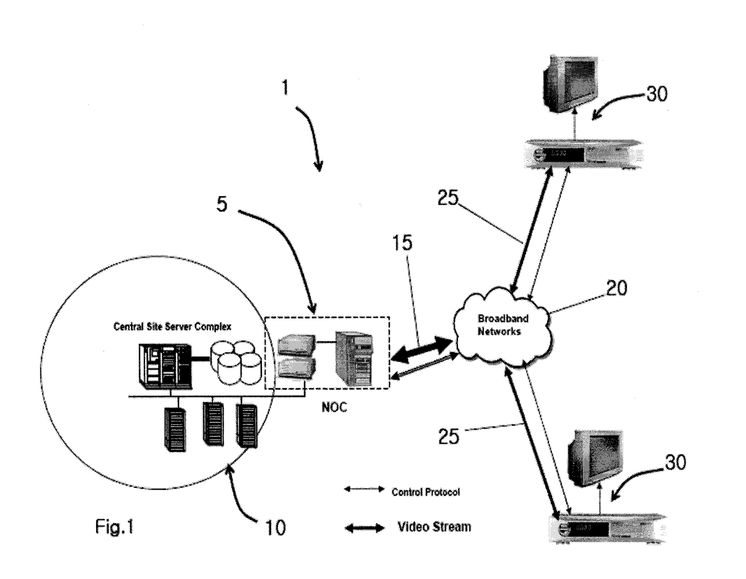

FIG. 1 illustrates the service structure of a very general and conventional IPTV network. As shown in FIG. 1, the NOC 5 is located in a particular location and controls all of the content of the central site server complex 10. Data and video streams from the NOC 5 pass through the main bandwidth of an internet connection 15. Video streams are transmitted to the end users 30 through their internet connections 15, 20 and 25.

In this service structure, the NOC 5 will have a limited number of channels due to the limit of the bandwidth of the internet connection 15. This is the same limitation that faces frequency-based and current IP-based television broadcasting, and, in principle, any frequency-based transmitting system.

The new platform of internet protocol based television broadcasting theoretically has no limitation of channels. Unfortunately, in practice, such a limitation exists because the NOC 5 is located in one physical place with all of its servers 10. Thus, the NOC 5 transmits all of its data and video stream through one bandwidth, which limits the number of channels. A change of the transmission base from a frequency-based transmitting system to an internet protocol (IP) network is not that meaningful to the end users 30.

Furthermore, the transition from a frequency-based transmitting system to an internet protocol (IP) network is difficult for users because it brings a more complicated usage platform, due to its non-assignment channels. Channels are defined with specific frequencies in the frequency domain, such as channel 7, channel 9, channel 36, and so forth. No commonly defined or specific channels are found in an internet protocol network, which means the channels are non-assignment channels.

One of the strong merits of the transition to an IP platform instead of a frequency-based platform is bidirectionality and video-on-demand (VoD). In the current IP network service structure, however, it is difficult to provide such services with unlimited channels and unlimited IP broadcasting or multicasting that include many VoD channels and live broadcasting simultaneously. Because of this limited bandwidth, limited television, and limited service for VoD, current IPTV service platforms do not achieve the full benefit of the transition from frequency-based to IP platform in television broadcasting.

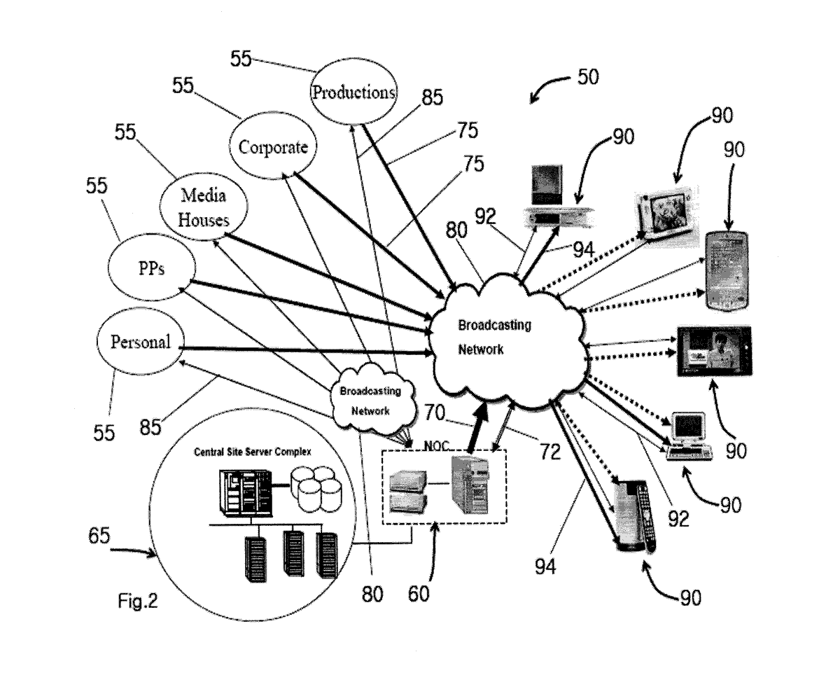

FIG. 2 illustrates a basic schematic of a distributed IPTV service structure 50 according to an embodiment of the present disclosure. A NOC 60 connected to a central site server complex 65 is provided, as in conventional IPTV systems. The program providers or channel providers 55, however, can provide their television broadcasting directly from their locations to the end users 90, bypassing the NOC 60. This is a very distributed broadcasting structure when compared with the conventional service structure 1 shown in FIG. 1. Any entity who wants to broadcast, such as individuals, program providers, media houses, corporations, and production agencies, can provide its television broadcasting at its location. Its broadcasting will not be bundled in a single bandwidth through the NOC 60, as in the conventional service structure 1.

The NOC 60 also can send a service stream 70, such as movie, sports and other videos which require higher resolution, just as conventional IPTV service providers do. The distributed IPTV service structure 50 thus contains a part of same service platform provided by current IPTV systems through their NOCs.

Each program provider 55 transmits its main video stream through its connection to the internet network 75 directly to the broadcasting network 80. The main video stream is delivered to the end users 90 through their connections 94 to the broadcasting network 80. The main video stream of the program provider 55 does not pass through the NOC 60.

At the same time, the NOC 60 controls each program provider 55 by exchanging data 85 through the broadcasting network 80, including service information, encryption management, and other of the control and management operations which are needed to make possible distributed IPTV services. The data 85 have their own encrypted protocol. The NOC 60 only handles its own high resolution video streams 70, and control data 85 for broadcasting the program providers 55.

The distributed IPTV service structure 50 allows the addition of more channels without overloading or exceeding the bandwidth of the NOC 60. The NOC 60 has no bottleneck in its bandwidth, because the main video streams 75 of the program providers 55 do not pass through the NOC 60. All of the program providers 55 are well distributed and each provides its video through its own connection to the broadband or internet network and passes through the broadband or internet network to be delivered to the end users 90 without passing through the NOC 60. In this structure, compared with the conventional service structure 1 as shown in FIG. 1, the NOC 60 only controls the management data 85 in addition to the main video stream 70. The management data 85 does not present a problem of bandwidth and traffic quality even when more channels are added because the management data 85 is very small compared to streaming video.

Each channel provider 55 provides its television broadcasting as if it was in the same location as all of the other channel providers 55 in the internet network. This transmission of television broadcasting is controlled using multicast and/or broadcasting and is encapsulated so that its entire stream signal appears as if came from the NOC 60. This means that the television channels are transmitted at the location of each provider 55. The locations of the providers 55 are actually well distributed, but in the view of the end user 90, the television broadcasting channels appear as if they were being transmitted from the NOC 60.

Total control of the television broadcasting network therefore is separated from its main video stream lines. As shown In FIG. 2, the main video stream lines 75 of the program providers 55 flow through the broadcasting network 80 (the internet in most cases) and are delivered to the end users 90. At the same time, the network control and management data flows between the NOC 60 and the channel providers 55 and is also transmitted from the NOC 60 to the broadcasting network along the data stream line 72 and then is delivered by the data stream line 92 to the end users 90. The end user 90 receives the main television video 70 and 75 from the broadcasting network 80 by way of the video line 94 (shown solid for a wired connection and dashed for a wireless connection) and the management data 92 at the same time as if both were from the NOC 60.

The NOC sends detailed information about content provider identifications to the receiving device of the end user 90. Accordingly, the end user's receiving device will have a list of broadcaster servers. The end user's receiving device includes the software needed to obtain this information.

The distributed IPTV service structure 50 permits the NOC 60 to extend its number of service channels without any serious bottleneck in its bandwidth. Furthermore, it provides opportunities to everyone who wants to make his or her own television broadcasting by lowering the entrance level.

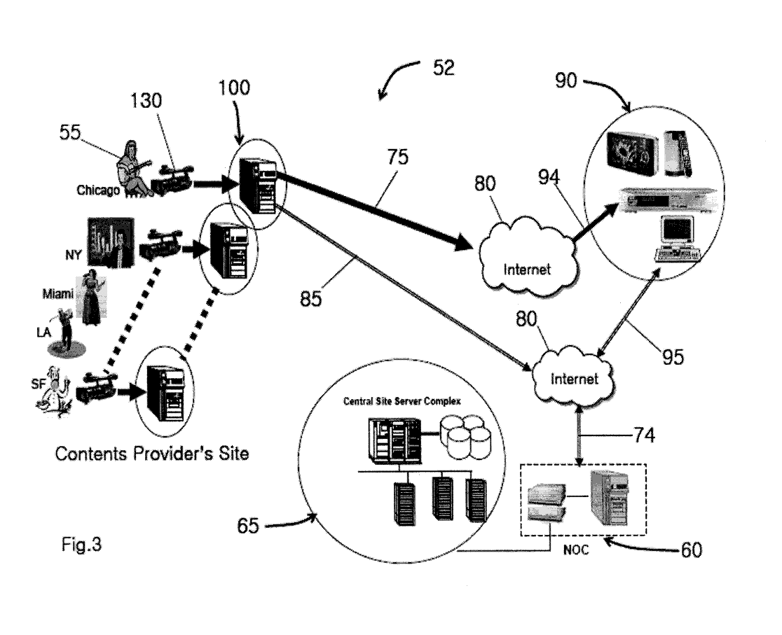

One embodiment of a means to lower the entrance level for the program provider 55 and help make practical a distributed IPTV broadcasting network 52 is shown in FIG. 3, which is a version of the system 50 shown in FIG. 2 with more detail concerning the sites of the program providers 55. A broadcaster server 100 is supplied to the content or program provider 55. The broadcaster server 100 is located at the site of each provider 55 and controls and manages its video stream 75 according to instructions of control operation sent by the NOC 60. The broadcaster server 100 helps accomplish this lowering of the entrance level for becoming a broadcaster.

The broadcaster server 100 receives audio and video signal from a camera and provides an output to be connected to a broadband network, preferably though an Ethernet connection. The broadcaster server 100 also has monitor and keyboard interfaces to be connected to a monitor and a keyboard, respectively. The program provider 55 connects the output (audio and video) of a camera 130 to the broadcaster server 100. The broadcaster server 100 encapsulates the audio and video data stream into packets for delivery over the internet as required by the control and management data protocol 85 supplied by the NOC 60. After the encapsulation of the main audio and video stream as requested by the NOC 60, the broadcaster server 100 delivers the encapsulated main audio and video stream through the internet line 75 to the broadcasting network 80.

The NOC 60 passes control data for control and cooperative operation of the receiving devices of the end users 90 via the internet pass through channels 74 and 95. The main audio video stream packets 75 and 94 are delivered to the end users 90 as shown in FIG. 3, in which the combination of control data and video from the NOC 60 is shown as a single stream 74 going to the broadcasting network 80 and a single stream 95 going to the end user 90, whereas the video 75 from the broadcaster server 100 is shown as a single stream 94 from the broadcasting network 80. The broadcaster server 100 provides separated video and control data output, however it outputs main video as if transmitted from the NOC 60 as in an IP multicast or broadcasting protocol format.

The total distributed IPTV broadcasting network system 50 can be structured by adding the broadcaster server 100 and encapsulating all of the distributed IPTV broadcasting signals as if they are transmitted from the NOC 60 even though they are well distributed. The end users 90 acknowledge and receive all of the television broadcasting signals as if from one source, the NOC 60. The NOC 60 only handles sending and receiving data 85 to and from program providers 55, sending some high resolution content 70 from its media servers 65 and control and management data for the terminals of the end users 90 through the internet network via the internet pass through channels 74 and 95. Therefore, the encapsulated main video stream which is generated by the broadcaster server 100 is delivered to the end user 90 directly 75, 80, and 94 and not passing through the NOC 60, but at the same time, the control and management data stream is delivered to the end user 90 by passing through the NOC 60.

This distributed IPTV structure 50 allows the NOC 60 to handle an unlimited number of channels, because the NOC 60 is requested to handle only the control and management data and not the main video stream of each program provider 55. One of the main functions of the broadcaster server 100 is to be controlled as a slave server, separate the main video and the control and management data, send the control and management data to the NOC 60, and transmit the encapsulated main video to the broadcasting network 80 as if it were delivered from an NOC operating with a multicasting or broadcasting protocol.

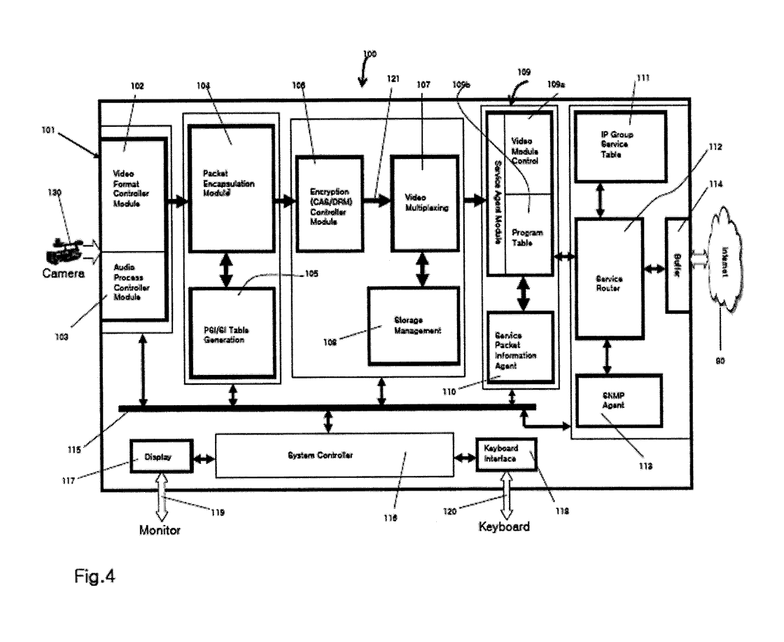

FIG. 4 shows a detailed block diagram of the broadcaster server 100. The broadcaster server 100 comprises many functional blocks to accomplish the functions described above. It has an input interface 101 to receive video and audio format signals from the output of the camera 130. The video format controller module 102 and the audio process controller module 103 receive video and audio signals, respectively, and regardless of whether they are analog or digital, convert them into a predetermined digital format so that the entire video and audio stream is transmitted with the same video and audio format regardless of its original video and audio format.

The video format controller module 102 and the audio process controller module 103 provide a very useful and convenient connection between the camera 130 and the television broadcasting signal 75, because the program provider 55 is required only to connect the camera 130 to the broadcaster server 100 without any detailed technical work or specialized knowledge. The video format controller module 102 and the audio process controller module 103 provide a means whereby normal people who have no technical knowledge about video, audio, cameras, and television broadcasting can do television broadcasting.

After the video and audio signals are converted into a unique format, the resulting signal is encapsulated into a predefined packet format by the packet encapsulation module 104 according to information from the predetermined packet service information (PSI)/service information (SI) table generation module 105. In this process, the audio video stream is packetized with its predefined service information. The packetizing process comprises a compression process and a detailed packetizing process with certain size of data structure.

The packetized audio video stream passes through the encryption controller module 106 to be encrypted using CAS (conditional access control) for broadcast streaming video and/or DRM (digital right management) techniques for downloads. After passing through the module 106, the main audio video stream is totally encrypted and fully controlled by the main subscribers and content management program in the NOC 60. The encrypted audio video stream later is matched with the software embedded in the end user's receiver or CPE (consumer premises equipment) to control access. After encryption, the main audio video stream is multiplexed by video multiplexing module 107 to meet the service architecture stream format and also managed for storage in the storage management module 108 in the broadcaster server 100.

The encrypted main audio video stream can be delivered to the service agent module 109 for processing and simultaneously can be saved in the storage management module 108 provided in the broadcaster server 100 for video-on-demand (VoD) services. The storage management module 108 also can be used for trailer video management by combining a saving function and an automatic pick-up function. The automatic trailer pick-up function can select a certain part of the audio video stream randomly, and transmit it as a trailer. There is no separate trailer video to be saved in any storage in the network in the whole system 50. This will save storage capacity.

The service agent module 109 comprises two functional blocks or agents and is supported by the service packet information agent 110. The video module control agent 109a provides service related information so that each class of signal will have its own identity and classification. Using this information, consumer premises equipment (CPE) can distinguish the class of video, for example, as a predefined category. The video module control agent 109a contains multiple classes each with its stream information such as size, time, bit rates, frame per second, and so on. The program table agent 109b controls all of the detailed information of program title, series, total number of series, time to broadcast, type of digital rights management (DRM) and conditional access system (CAS), type of services such as payment types (flat, monthly, PPV, and so forth).

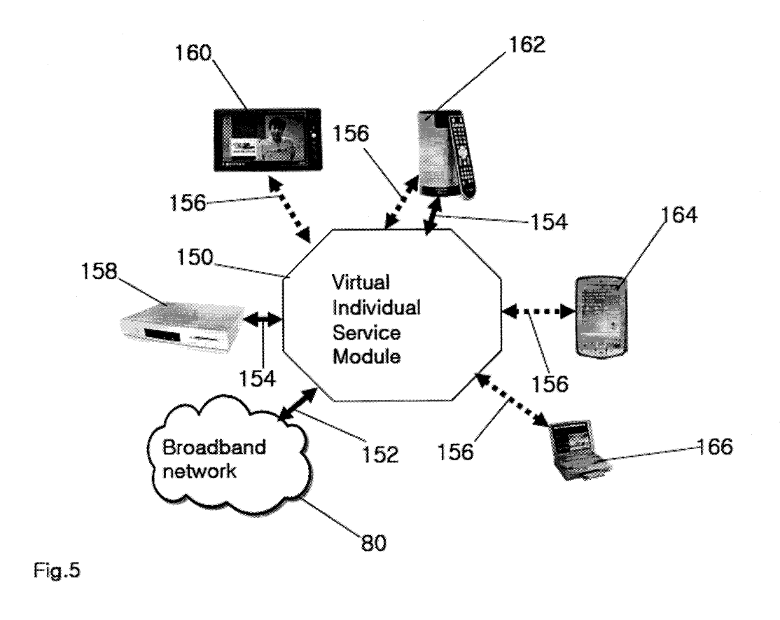

While the service agent module 109 processes the main audio video stream with the video module control 109a and the program table module 109b, the service packet information agent 110 also adds program packet data into the encrypted main audio video stream. The service packet information agent 110 controls the stream and packetizes the stream for multicast or broadcast or VoD according to the instructions of the system controller 116. The service packet information agent 110 also generates data to support the virtual individual service network function discussed below in connection with FIG. 5. The service packet information agent 110 generates encapsulation of network routing information so the output of the broadcaster server 100 is transmitted as if it was transmitted from the NOC 60.

The next processing is very general internet protocol processing in the SNMP agent 113, the IP group service table 111, and the service router 112, which are connected to the broadcasting network 80 interfaced with the buffer 114.

The overall functions of the broadcaster server 100 are fully controlled by the system controller 116 through its system control bus 115. This system control bus 115 is well separated from main video stream line.

The broadcaster server 100 also provides a display interface 117 and a keyboard interface 118 for monitoring and inputting data, respectively. A monitor 119 can be connected to the display interface 117 and a keyboard 120 (or wireless remote controller receiver) can be connected to the keyboard interface module 118. Through this display device, a program provider 55 can monitor its television broadcasting display in real time, including the level of the audio signal.

The combined process of all the functional blocks in the broadcaster server 100 generates distributed IPTV signals and is controlled to meet technical and operational requirements according to the instructions the NOC 60.

FIG. 5 shows a basic diagram of a virtual individual service module 150 that is implemented by software in the NOC 60. This is a virtual device software module to support different types of end user devices. The virtual individual service module 150 allows an end user (such as the end user 90 of FIGS. 2 and 3) to use different types of devices such as a set top box (STB) 156, a portable media player (PMP) 160, portable video recorder (PVR), personal computer (PC) 166, and a smart phone 164. The end user 90 can watch the same content using any of the different devices whether they are connected to the virtual individual service module 150 with either a wire connection 152 or a wireless connection 154.

The virtual individual service module 150 supports the end user 90 without any breaking or interruption of the contents being received, as if the contents were viewed in a single unit. Assuming that the end user 90 selects a program which consists of twenty episodes of drama and watches its first five episodes using the STB 162 and after that the end user 90 watches again using the PMP 160. In this case, the PMP 160 does not recognize automatically which episode is the last one viewed by the end user. The virtual individual service module 150, however, retains all of this information so the next episode is delivered to the selected device automatically even when the end user 90 changes the device.

The end user 90 therefore can switch viewing devices as much as he or she wishes, as shown in FIG. 5, without losing his or her viewing record. The virtual individual service module 150 is very useful to receive any content which consists of multiple episodes, because the virtual individual service module 150 transmits the correct next episodes of the reserved contents even if the end user 90 changes the viewing device.

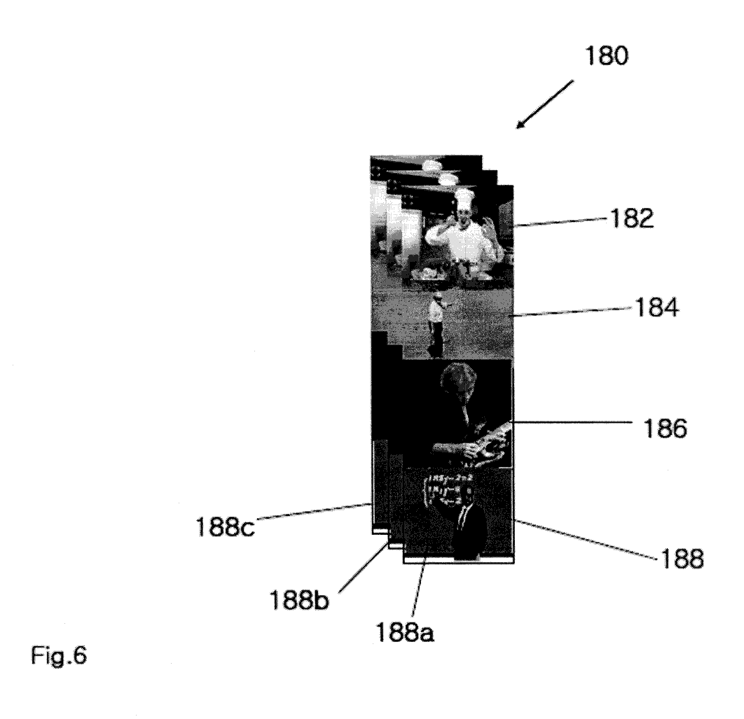

The virtual individual service module 150 supports the automatic fill-up function described below in connection in FIG. 6. The virtual individual service module 150 keeps all of the reserved channel data and program data, including reservation, viewing record, channel subscription, and so forth. The virtual individual service module 150 provides easy access and program reservation to support more portability and continuity of service regardless of the type of end user device. The virtual individual service module 150 is a program that operates as it is a device operating in the network available to the end user but it is operated in a server located at the NOC 60.

FIG. 6 illustrates the hierarchical structure of channels 180 that operates in the end user's viewing device or CPE. This structure is implemented by software in the CPE with basic information supplied by the virtual individual service module 150.

Television broadcasting based on an IP network has no pre-assigned channel order or number such as is commonly used in current frequency based television broadcasting. A preferred system according to the disclosure provides a number of channels as a basic package and more can be added for an additional charge.

The end user can name or identify each channel as he wants, for example: news, drama, movie, sports, and so forth. Each channel 180 comprises several slots and each slot comprises several layers. This combination of slots and layers can be provided as one channel and more can be added for an extra payment.

In the exemplary structure shown in FIG. 6, the channel 180 corresponds to four slots 182, 184, 186, and 188, and each slot contains three layers. Thus, slot 188 contains layers 188a, 188b, and 188c. Each slot 182, 184, 186, and 188 can contain a program. Each layer of a slot, such as layers 188a, 188b, and 188c of slot 188, contains a particular episode of a program (as shown in FIG. 6, a news program) and is automatically filled-up by control data from the NOC 60. Accordingly, the channel 180 can accommodate four programs (one for each slot) and three episodes of each program (one for each layer).

Once the end user 90 watched one episode of the series of episodes of the program, the watched episode is removed from the first layer and automatically filled up with the next episode from the second layer. The episode from the third layer then fills up the second layer, and so on. The end user 90 does not need to select the episode every time, because it is automatically updated for as many layers as are provided for each channel.

For example, suppose the end user 90 subscribes to a daily news program and assigns this program to the slot 188. Three layers are provided for each slot in the structure shown in FIG. 6. The end user's receiving device will save the first through third episodes or shows of the news program, one for each layer. After the end user watches the first and second episodes or shows the two watched episodes or shows are removed from the first and second layers 188a and 188b, respectively. The third episode or show will advance from the third layer 188c to the first layer 188a and the broadcaster server 100 or the NOC 60 will load the fourth and fifth episodes or shows onto the second and third layers 188b and 188c, respectively. The end user does not need to select this news program again to receive the rest of the episodes or shows of the daily news program.

The channel function described in connection with FIG. 6 is supported by the virtual individual service module 150 described in FIG. 5. The end user will be able to easily access all unviewed episodes of his or her favorite program.

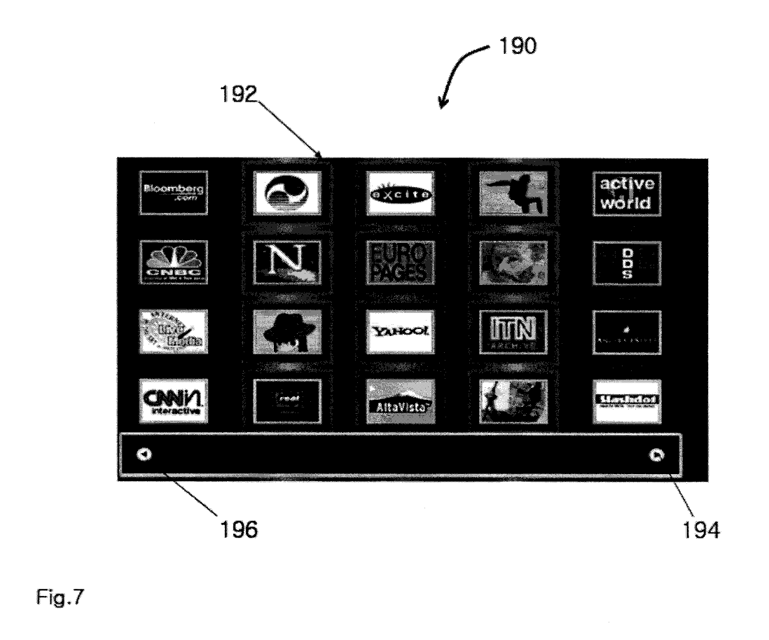

FIG. 7 shows the display of a television screen 190 which is designed with an icon base graphic user interface page 192. The graphic user interface 192 provides easy access, searching and selection of channels and is enabled by software based in the end user's viewing devices or CPE, such as a set top box (STB), personal computer, portable media player, and personal video player. The icon base graphic user interface page 192 displayed on the screen 190 can be viewed as a series of page units by clicking the forward arrow button 194 and the back arrow button 196 on the screen 190 in order to search for programs or channels. This icon based graphic channel display provides a user interface for the search function that is a more visual alternative to the current widely used alphabetical display.

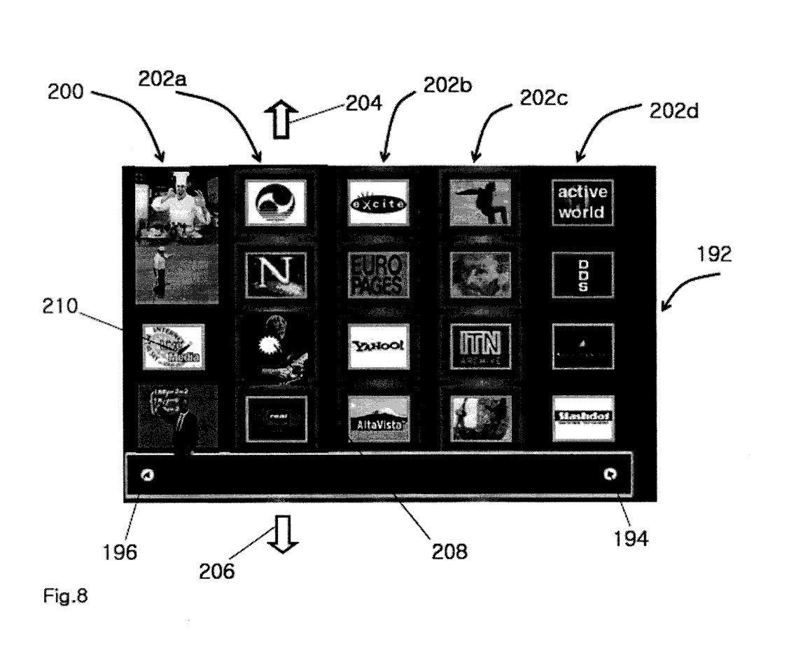

FIG. 8 illustrates the detailed operation of the icon base graphic user interface page 192. The channels that are named by the end user are displayed in the far left column lane 200. A “name” is an icon or picture that represents a channel, and four are shown in FIG. 8. The channels that are available from broadcasters are shown in the four columns 202a-202d can be searched by moving up and down each of the columns 202a-202d by pressing the up and down buttons of the end user's remote controller (the up and down buttons are represented symbolically by the arrows 204 and 206, respectively).

The end user may want to select one channel, such as the one in column 202b indicated by reference numeral 208, and save it into the named channel 210 in column 200. The end user may click on the channel 208 and drag it onto his named channel 210 using the click and cursor buttons of his or her remote controller or other input device (such as a mouse for a personal computer).

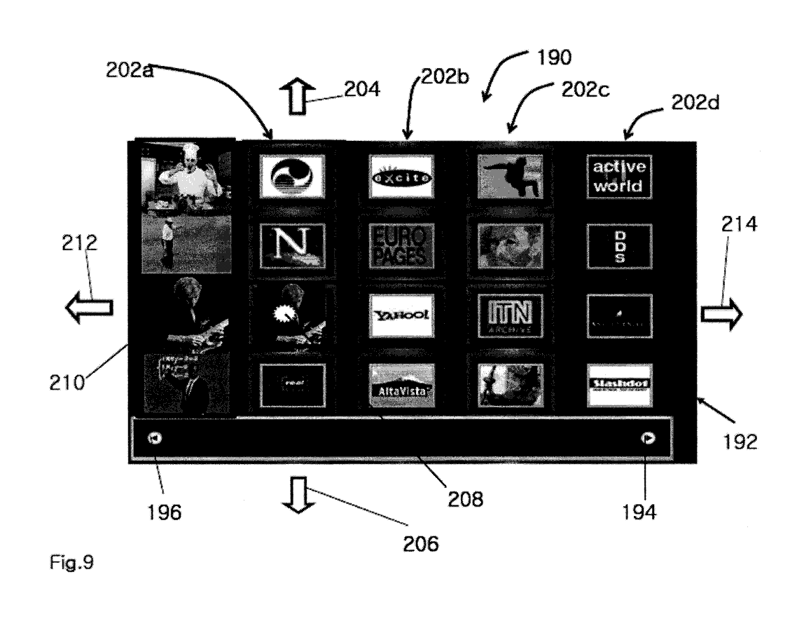

FIG. 9 shows how to select a channel and save it onto the named channel list. The far left column 200 shows the named channel list and now the second left column 202a has been selected to search. The user can surf the list of the channels by using the up and down arrow button of the remote controller, 204 and 206. If the end user wants to select the guitarist channel 208, he or she just puts the cursor onto the channel 208 and drags and clicks the cursor to the slot 210 that is to receive it. Then a new program can be saved with the selected channel 210 in a slot as described in connection with FIG. 6.

As described above, the end user can search by selecting columns. The end user can also search by rows as well. The end user can search by rows by using the left and right arrow button of the remote controller, 212 and 214. The end user therefore may easily search by column or row, select a channel, and add it into the user-named channel list just by using the cursor buttons of the remote controller.

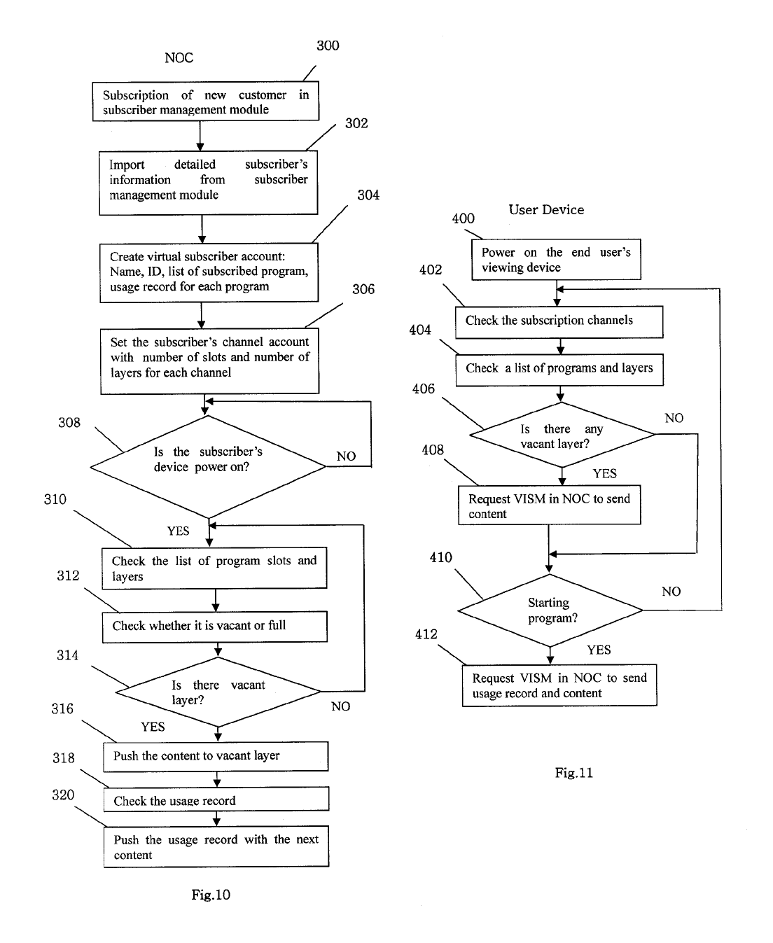

FIG. 10 is a flow chart depicting aspects of the method of operation of the virtual individual service module in the NOC 60. The method is carried out in a computer or server in the NOC 60 as instructed by software operating in the computer or server and retained in computer-readable memory.

In step 300, a subscriber management module in the NOC 60 records the information about a subscriber when an end user becomes a subscriber to the broadcasting system. In step 302, a virtual individual service module (VISM) in the NOC 60 imports the information about the new subscriber from the subscriber management module. The VISM creates a new account with the imported data including name, subscriber's identification, list of subscribed programs, usage record for each program, subscriber's type of devices, and information concerning the subscriber's channel structure (number of slots and layers) in step 304. The VISM also sets the end user's channels with their number of slots and layers in step 306.

In step 308 the VISM continually monitors whether the end user's receiver device is in a power on or power off state. If the end user's device is in the power on state, then the VISM checks the list of program slots and layers in step 310. In this stage, VISM also receives the request for data from the user device (step 408 in the flow chart of FIG. 11). After that step, the VISM checks whether each layer in the end user's account is vacant or full in step 312. If there is a vacant layer 314, the VISM then obtains information about this vacant layer and pushes the content for this vacant layer automatically in step 316 (or as requested by the end user's device in step 408).

The VISM then checks the usage record in step 318. Upon receipt of a request from the end user's device in step 412, in step 320, it then pushes the usage record to the end user's device. The usage record is a record held in the VISM of which programs the end user watched, using any of his or her devices. The usage record is pushed onto the user's device so that the user will be able to watch the next episode of the program without having to remember which episode he or she last watched, even if the end user changes devices, such as from STB to PMP, because the device will be able to consult the usage record in order to play the next episode in order.

FIG. 11 is a flow chart depicting aspects of the method of operation of the end user's device in cooperation with the VISM in the NOC 60.

When the end user turns on the power of his or her receiver device in step 400, the device checks the subscribed channels in step 402 and a list of programs and layers in step 404. Upon determination that a layer or channel is vacant in the step 406, the device sends a request to the VISM in the NOC 60 to push the content in the step 408 and receive and save the content from the NOC in the step 316.

Upon determination that no vacant layer exists or upon completion of the operation for requesting content for a vacant layer in steps 316 and 408, the device waits for the user's instruction to start a program in the step 410. If the end user provides an instruction to start any program, then in step 412 the device requests the usage record and content from the NOC and receives the usage record and content from the NOC in step 320.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices may likewise be constructed to implement the methods described herein. Furthermore, alternative software implementations including, but not limited to, distributed processing or component/object distributed processing, parallel processing, or virtual machine processing may also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

1. A method of providing internet protocol television content to at least one end user from a plurality of distributed content providers broadcasting over a broadcasting network in association with a network operations center, comprising the following steps:
providing broadcasting content from the plurality of distributed content providers to the end user directly and not passing through the network operations center;
remotely controlling the plurality of distributed content providers from the network operations center by passing management and control data between the plurality of distributed content providers and the network operations center;
wherein the end user may select desired content to receive the desired content from one or more of the plurality of distributed content providers directly over the broadcasting network.

2. The method according to claim 1 wherein the desired content is transmitted as encapsulated main video to the broadcasting network as if it were delivered from a network operating center operating with a multicasting or broadcasting protocol.

3. The method according to claim 2 wherein the broadcasting network is the internet.

4. The method according to claim 1, further comprising the step of providing a broadcaster server to each content provider at the site of the content provider, the broadcaster server having access to the content of each content provider, wherein the broadcaster server receives management and control data from the network operation center.

5. The method according to claim 4 wherein the broadcaster server broadcasts the content to the end users directly and not passing through the network operation center over the broadcasting network.

6. The method according to claim 4 wherein the broadcaster server has encryption, service related information and content streaming output functions that are controlled by the network operation center remotely.

7. The method according to claim 4 wherein the broadcaster server transmits encapsulated broadcasting content as if it comes from the network operation center.

8. The method according to claim 5 wherein the desired content is streaming output and the broadcaster server comprises a conditional access system and a digital rights management system, and further comprising the step of encrypting the streaming output by the conditional access system and the digital rights management system simultaneously.

9. The method according to claim 8 further comprising the steps of:
providing a consumer premises equipment to each of the end users wherein the consumer premises equipment is adapted for receiving the encrypted streaming output of the broadcaster server; whereby the consumer premises equipment de-encrypts the streaming output from the broadcaster server in the consumer premises equipment and makes the desired content available to the end user.

10. The method according to claim 9 wherein the consumer premises equipment comprises a conditional access system and a digital rights management system and the conditional access system de-encrypts the encrypted streaming input and the digital rights management system determines whether the desired content may be stored.

11. A distributed network structure for providing internet protocol television content from a plurality of distributed content providers broadcasting over a broadcasting network to at least one end user, comprising:
a network operations center in communication via the network with each of the plurality of content providers and the end user wherein the network operations center remotely controls the plurality of distributed content providers from the network operations center;
a broadcaster server provided to each content provider at the site of the content provider, the broadcaster server having access to the internet protocol television content of the associated content provider, wherein the broadcaster server receives management and control data from the network operation center and broadcasts the internet protocol television content directly from the associated content provider through the broadcast network to the end user and not passing through the network operations center;
wherein the end user may select desired content to receive the desired content from one or more of the plurality of distributed content providers directly over the broadcasting network.

12. The distributed network structure according to claim 11, wherein each of the broadcaster servers comprises an input for video and audio signals and a module for converting the video and audio signals received from the input into a predetermined format.

13. The distributed network structure according to claim 11, wherein each of the broadcaster servers comprises a module for performing management control.

14. The distributed network structure according to claim 11, wherein each of the broadcaster servers comprises a module for interfacing with a network.

15. The distributed network structure according to claim 11, wherein each of the broadcaster servers comprises a module for performing packet encapsulation module, an encryption module, a video multiplexing module, service agent module, and an internet service group.

16. The distributed network structure according to claim 11, wherein each of the broadcaster servers comprises a module for performing management of protocol data through an audio/video process controller, a packet table generator, a storage management, a service packet information agent, and internet agent.

17. The distributed network structure according to claim 11, wherein each of the broadcaster servers comprises a module for performing monitor output.

18. The distributed network structure according to claim 11, wherein each of the broadcaster servers comprises a module for performing keyboard input.

19. The distributed network structure according to claim 11 further comprising a virtual individual service module hosted in the network operations center wherein the virtual individual service module maintains a usage record and list of type of receiving devices for each end user.

20. The distributed network structure according to claim 19 wherein the end user has a plurality of receiving devices and the virtual individual service module maintains the continuity of the viewing experience of the end user when the end user changes the receiving device.

21. The distributed network structure according to claim 11 wherein each broadcaster server comprises a conditional access system, a digital rights management system, and a system for charging the end user for payment for receipt of desired content, the system for charging being configured so that the content provider may set the amount to be charged independent of the amount charged by any other content provider.

22. The distributed network structure according to claim 20 wherein the end user devices comprise a function to set up private channels, each of the private channels comprising a certain number of slots, and each of the slots comprising a certain number of layers.

23. The distributed network structure according to claim 22 where the virtual individual service module has a function to push the content to the end user device's layers automatically when a layer is empty.
